(19) United States
(12) Patent Application Publication
(10) Pub. No.: US 2023/0264536 A1
(43) Pub. Date: Aug. 24, 2023

(54) AIR PRESSURE ADJUSTING DEVICE AND METHOD FOR OPERATING THE SAME

(71) Applicant: AISIN CORPORATION, Kariya (JP)

(72) Inventors: Yukihiro AKIYAMA, Kariya-shi (JP); Yukihiko TAKEMI, Kariya-shi (JP); Ken OGUE, Kariya-shi (JP)

(73) Assignee: AISIN CORPORATION, Kariya (JP)

(21) Appl. No.: 18/158,075

(22) Filed: Jan. 23, 2023

(30) Foreign Application Priority Data
Feb. 21, 2022 (JP) 2022-024486
May 24, 2022 (JP) 2022-084301

(51) Int. Cl. B60G 17/052; B60G 11/27; B60G 17/015; B60G 17/04

(52) U.S. Cl. CPC B60G 17/0525; B60G 11/27; B60G 17/0155; B60G 17/0408; B60G 17/0528; B60G 2400/51222; B60G 2600/66; B60G 2800/914

(57) ABSTRACT

An air pressure adjusting device includes a compressor configured to compress air taken in from outside, a dryer connected to the compressor and filled with a reversible dehumidifying agent, a connection port through which air dehumidified by the dryer is supplied to another device, an exhaust valve provided between the compressor and the dryer and configured to discharge air in the dryer, and a switch valve provided between the dryer and the connection port and configured to switch between a first flow path having a large air flow rate and a second flow path having a small air flow rate.

### CROSS REFERENCE TO RELATED APPLICATIONS

This application is based on and claims priority under 35 U.S.C. §119 to Japanese Patent Applications 2022-024486, filed on Feb. 21, 2022, and 2022-084301, filed on May 24, 2022 and the entire content of which is incorporated herein by reference.

### TECHNICAL FIELD

This disclosure relates to an air pressure adjusting device including: a compressor that compresses external air; a dryer that dehumidifies flowing air; a connection port through which the compressed air is supplied to another device such as an air suspension; and an exhaust valve that discharges the air in the compressor, in order to adjust a height of a vehicle provided with, for example, an air suspension, and a method for operating the same.

### BACKGROUND DISCUSSION

In the related art, as such an air pressure adjusting device, there is, for example, one disclosed in JP 2002-087040A (Reference 1) (see paragraphs [0009] to [0013] and FIG. 1).

As the air pressure adjusting device, in particular, a compact and low-cost air pressure vehicle height adjusting device that can reduce a vehicle height within a short period of time and that has excellent dehumidifying-and-regenerating efficiency of a dehumidifying agent in a dryer is to be provided.

Specifically, the air pressure adjusting device includes a compressor 1 that compresses air, a dryer 3 filled with a reversible dehumidifying agent, a tank 5 that stores air, and air suspensions 7 that adjust a vehicle height by increasing or decreasing an air pressure. The dryer 3, a one-way throttle valve 9 that performs throttling only in a direction from the air suspension 7 toward the dryer 3, and vehicle height adjusting valves 11 are provided in this order between a discharge side of the compressor 1 and the air suspension 7.

A first tank valve 13 is provided between the vehicle height adjusting valves 11, the one-way throttle valve 9 and the tank 5, and a second tank valve 15 is provided between the tank 5 and a suction side of the compressor 1. An exhaust valve 17 that releases air in a circuit to the atmosphere is provided between the dryer 3 and the discharge side of the compressor 1.

These configurations are controlled by a control unit 19, and at the time of increasing the vehicle height, the first tank valve 13 and the exhaust valve 17 are closed and the vehicle height adjusting valves 11 are open to operate the compressor 1. On the other hand, at the time of reducing the vehicle height, the second tank valve 15 and the exhaust valve 17 are closed, and the vehicle height adjusting valves 11 and the first tank valve 13 are open within a predetermined time from start of a lowering control. When the vehicle height is not reduced to a target vehicle height after the predetermined time elapses, based on this state, the first tank valve 13 is closed, the exhaust valve 17 is open, and accordingly the remaining air in the air suspension is discharged.

Therefore, the tank 5 that stores air is provided on an exhaust circuit side, and at the time of reducing the vehicle height, the compressed air in the air suspension is released by an amount that can be accumulated in the tank 5, and the vehicle height is controlled to be reduced. That is, a capacity of the tank 5 is set to a small capacity that can be handled within a range of vehicle height adjustment that can frequently occur, and the predetermined time is set to a time required for vehicle height reducing control within the range. The compressed air to be released to the tank does not pass through the throttle, and a vehicle height reducing time is shortened.

In the air pressure adjusting device in the related art, dry air discharged to the tank 5 can be supplied to the suspension again, and the vehicle height can be adjusted without newly compressing the outside air by the compressor at the time of the next vehicle height increase.

When the vehicle height is not reduced to the target vehicle height within the predetermined time, based on this state, by closing the first tank valve and opening the exhaust valve, the compressed air in the air suspension is released from the exhaust valve 17 after passing through the one-way throttle valve 9 and the dryer 3. For example, when it is desired to quickly reduce the vehicle height by a certain height in a case in which a passenger gets on or off a vehicle or a case in which a load is loaded or unloaded, it is necessary to release air through the one-way throttle valve 9, and thus a speed cannot be ensured.

Since it is necessary to separately provide the tank 5, not only a size or a weight of the device is increased, but also it is necessary to control a valve or the like attached to the tank 5, which complicates a configuration of the device.

The air pressure adjusting device in the related art has various problems to be solved, such as a problem that air cannot be efficiently discharged. A need thus exists for an air pressure adjusting device which is not susceptible to the drawback mentioned above.

### SUMMARY

### Characteristic Configuration

An air pressure adjusting device according to this disclosure includes: a compressor configured to compress air taken in from outside; a dryer connected to the compressor and filled with a reversible dehumidifying agent; a connection port through which air dehumidified by the dryer is supplied to another device; an exhaust valve provided between the compressor and the dryer and configured to discharge air from the dryer; and a switch valve provided between the dryer and the connection port and configured to switch between a first flow path having a large air flow rate and a second flow path having a small air flow rate.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side cross-sectional view illustrating a configuration of an air pressure adjusting device according to a first embodiment;

FIG. 2 is a plan cross-sectional view illustrating the configuration of the air pressure adjusting device according to the first embodiment;

FIG. 3 is a block diagram showing the configuration of the air pressure adjusting device according to the first embodiment;

FIGS. 4A and 4B are diagrams illustrating an operation mode of a switch valve according to the first embodiment;

FIGS. 5A and 5B are diagrams illustrating an operation mode of a switch valve according to a second embodiment;

FIG. 6 is a block diagram showing a configuration of an air pressure adjusting device according to a third embodiment; and

FIGS. 7A to 7E are diagrams illustrating an operation mode of an air pressure adjusting device according to the third embodiment.

### DETAILED DESCRIPTION

### First Embodiment

### Overview

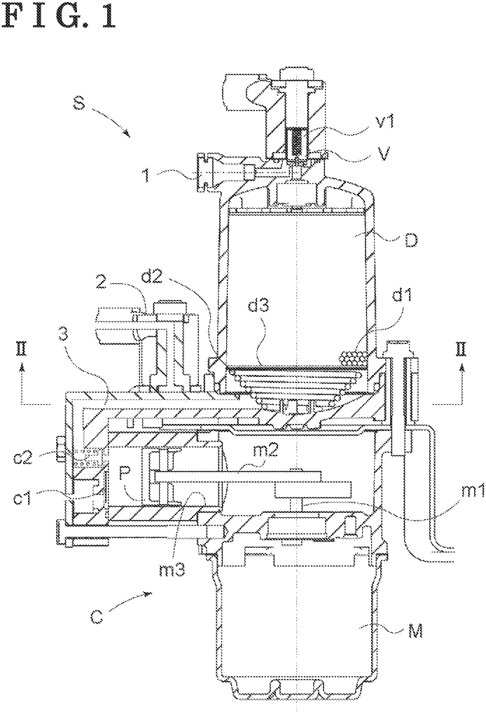

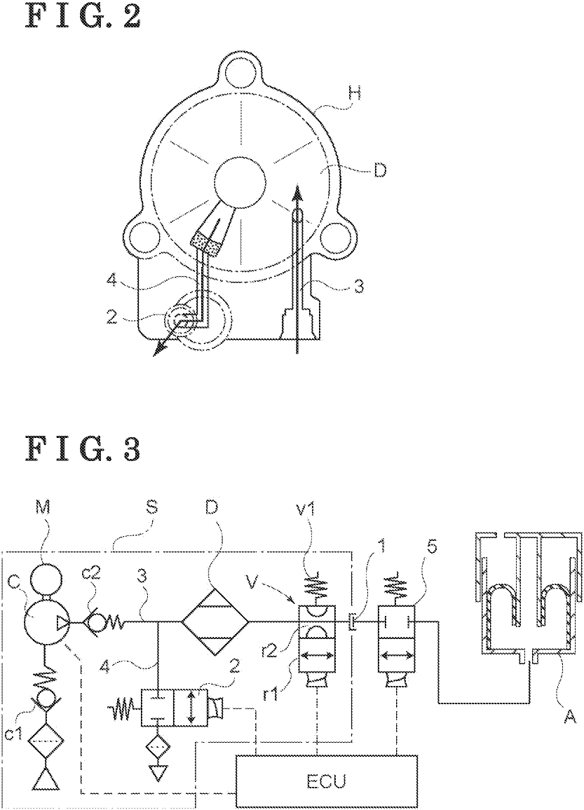

FIGS. 1 and 2 are cross-sectional views illustrating an air pressure adjusting device S (hereinafter simply referred to as “device S”) according to a first embodiment disclosed here, and FIG. 3 is a block diagram showing a configuration of the device S. Specifically, the device S includes: a compressor C provided with a motor M and a piston P that compress air taken in from the outside; a dryer D connected to the compressor C and filled with a dehumidifying agent d1; a connection port 1 through which air dehumidified by the dryer D is supplied to another device; and an exhaust valve 2 that is provided between the compressor C and the dryer D and that discharges air in the dryer D.

As illustrated in FIG. 1, the motor M is provided at a lower portion of the device S and includes a rotation shaft m1. The piston P is provided on the rotation shaft m1 via a connecting rod m2, and reciprocates inside a cylinder m3. The cylinder m3 is provided with a suction valve c1 that takes in air from the outside and a discharge valve c2 that guides the air compressed by the piston P to the dryer D on a top portion thereof. The suction valve c1 and the discharge valve c2 are one-way valves.

The compressed air discharged from the discharge valve c2 is supplied to a lower portion of the dryer D via a supply path 3 disposed outside the cylinder m3. The dryer D is filled with a reversible dehumidifying agent d1, and the reversible dehumidifying agent d1 temporarily absorbs moisture that aggregates as the air is compressed. The dehumidifying agent d1 is positioned and fixed in an upper space by a perforated plate d3 provided on the lower portion of the dryer D together with a spring d2 so as not to move and be crushed.

### Switch Valve

In the present embodiment, as illustrated in FIG. 4, a switch valve V is provided on a top portion of the dryer D and between the dryer D and the connection port 1. The switch valve V can switch an air flow path between the dryer D and the other device between a first flow path r1 having a large air flow rate and a second flow path r2 having a small air flow rate. The reason why the second flow path r2 having a small air flow rate is provided is to reduce an amount of air flowing into the dryer D to decrease an internal pressure of the dryer D, and to promote removal of moisture by flowing dry air to enhance a regenerating property of a dehumidifying agent, particularly at the time of the exhaust of the dryer D.

The air compressed by the compressor C is supplied to the other device via the switch valve V, or the air discharged from the other device is returned to the dryer D and released from the exhaust valve 2. The dryer D is filled with the dehumidifying agent d1 having reversibility, and when air is compressed by the compressor C, condensed moisture is absorbed. When the compressed air is discharged, the moisture previously absorbed by the dehumidifying agent d1 is taken away to the outside again by the dry air returned to the dryer D.

As illustrated in FIG. 2, the supply path 3 of the compressed air extending from the compressor C to the dryer D and a discharge path 4 of exhaust air extending from the dryer D to the exhaust valve 2 are provided at different positions in substantially the same plane. The exhaust valve 2 has a solenoid, and can change a position of a valve body between an open state and a closed state.

As shown in FIG. 3 and FIGS. 4A and 4B, the first flow path r1 is a flow path having a large diameter, and the second flow path r2 is provided with an orifice having a throttle function.

As shown in FIG. 3, the switch valve V includes a spring v1, and the second flow path r2 is always selected. In addition, as shown in FIGS. 4A and 4B, the switch valve V includes a cylindrical coil v2 and a valve body v3 that reciprocates at a center of the coil v2. The valve body v3 functions as a plunger of the solenoid. Therefore, the first flow path r1 and the second flow path r2 of this configuration are switched according to extension or retraction of the valve body v3 with respect to the coil v2.

The valve body v3 is, for example, a cylindrical member, and includes a spring chamber v4 in which the spring v1 is provided at a central portion thereof. The valve body v3 protrudes from the coil v2 and is biased by the spring v1. An annular valve seat h1 is formed integrally with a housing H at a tip from which the valve body v3 protrudes. For example, an annular seal rubber v5 is attached to a tip of the valve body v3, and can be brought into close contact with the valve seat h1. FIG. 4A shows a state in which the valve body v3 is in contact with the valve seat h1, and FIG. 4B shows a state in which the valve body v3 is separated from the valve seat h1.

Two hole portions forming the second flow path r2 are formed in the valve body v3. One hole portion is a first hole r21 penetrating the valve body v3 in a direction orthogonal to an axis center X of the valve body v3, and the other hole portion is a second hole r22 communicating with the first hole r21 from the tip of the valve body v3 along the axis center X of the valve body v3. In particular, a hole diameter of the second hole r22 is determined to be a predetermined size so as to exhibit a function of the orifice. In addition, the first hole r21 is open in two directions of the valve body v3, and a total of two opening areas is set to be larger than a cross-sectional area of the second hole r22.

In FIG. 4A in which the second flow path r2 is selected, the valve body v3 comes into contact with the valve seat h1, and the first flow path r1 is closed. On the other hand, the second flow path r2 is open to a side portion of the valve body v3 protruding from the coil v2, and the dryer D and the connection port 1 communicate with each other. FIG. 4B illustrates a state in which the switch valve V is energized, the valve body v3 retracts against a biasing force of the spring v1, and the valve body v3 separates from the valve seat h1. Accordingly, the second flow path r2 moves to the inside of the coil v2 and is closed, and the first flow path r1 is selected.

An opening area of the first flow path r1 is determined by a gap formed along an entire circumference of the valve seat h1, and an opening area of the second flow path r2 is determined by, for example, a size of the second hole r22 penetrating the valve body v3. On the other hand, the first flow path r1 formed along the entire circumference of the valve seat h1 can have a large opening area according to a movement distance of the valve body v3. With this configuration, the first flow path r1 and the second flow path r2 having different air flow rates can be likely to be formed with a simple configuration.

With this configuration, when the switch valve V is not energized, the valve body v3 comes into contact with the valve seat h1, and the second flow path r2 having a small air flow rate is open in a normal state. In a state in which the second flow path r2 functions, even when a pressure of the other device connected to the connection port 1 is high, the opening of the second flow path r2 with respect to the connection port 1 is oriented in a direction intersecting a reciprocation direction of the valve body v3, and thus the valve body v3 does not unexpectedly move due to the pressure of the other device. Therefore, the flow of air can be reliably controlled.

With the valve body v3 of this configuration, when high-pressure air is supplied to the other device, the opening of the second flow path r2 with respect to the dryer D is oriented in a direction along the reciprocation direction of the valve body v3. In principle, an opening operation of the valve body v3 is performed by energizing the switch valve V, and when the internal pressure of the dryer D is high, a high pressure acts on the valve body v3 in a direction in which the valve body v3 is pushed into. Therefore, when the switch valve V is energized, the valve body v3 moves quickly, and the high-pressure air can be quickly supplied to the other device.

As described above, in the present embodiment, the switch valve V is provided between the dryer D and the connection port 1 so that the first flow path r1 having a large air flow rate can be selected. Accordingly, for example, when the air is discharged from the other device, the air can be discharged from the exhaust valve 2 by flowing a large flow rate of air through the dryer D. At this time, a regeneration function of the dryer D for removing the moisture from the dehumidifying agent d1 is not sufficiently exhibited, but with this configuration, the air in the other device can be quickly discharged.

Therefore, for example, when another device to which the air pressure adjusting device S according to the present embodiment is connected is an air suspension A, air in the air suspension A can be quickly discharged, and a vehicle height can be quickly adjusted down.

### Operation Mode

An operation mode of the device S will be described again with reference to FIG. 3. For example, when the air suspension A according to the present embodiment is provided in a bus and the vehicle height is increased, the following operation is performed.

A control device ECU sets the exhaust valve 2 to a closed state, sets the switch valve V to the second flow path r2, and sets an opening and closing valve 5 attached to the air suspension A to a closed state. Next, the compressor C is operated, and air is accumulated in the dryer D while being compressed. When a certain amount of compressed air is accumulated in the dryer D, the opening and closing valve 5 is set to an open state to supply the compressed air to the air suspension A.

At this time, in the dryer D, moisture in the compressed air is absorbed by the dehumidifying agent d1, and moisture in a form of water droplets is temporarily stored in the lower portion of the dryer D. When exhaust air passes through the dryer D in a reverse direction, the moisture absorbed by the dehumidifying agent d1 is taken away by the exhaust air. In addition, the moisture stored in the lower portion of the dryer D is discharged together with the exhaust air via the discharge path 4 and the exhaust valve 2.

When the air suspension A rises to a predetermined height, the opening and closing valve 5 is closed and the compressor C is stopped. Accordingly, the discharge valve c2, which is a one-way valve provided on the compressor C, prevents backflow of the compressed air in the dryer D, and air at a predetermined pressure is stored in the dryer D. The compressed air in the dryer D may be once discharged by opening the exhaust valve 2.

When the vehicle height is reduced, the exhaust valve 2 is set to an open state. Accordingly, when the high-pressure air remains in the dryer D, the discharge of the air starts. In accordance with this, the switch valve V is energized to be set to the first flow path r1, and the opening and closing valve 5 is set to an open state. Accordingly, high-pressure air in the air suspension A is discharged from the exhaust valve 2 via the dryer D.

At this time, since the switch valve V is set to the first flow path r1, the high-pressure air in the air suspension A is rapidly discharged, and the vehicle height is rapidly controlled to be reduced. Since a large flow rate of exhaust air passes through the dryer D, an amount of moisture absorbed by the dehumidifying agent d1, which is taken away by the exhaust air, is small.

### Second Embodiment

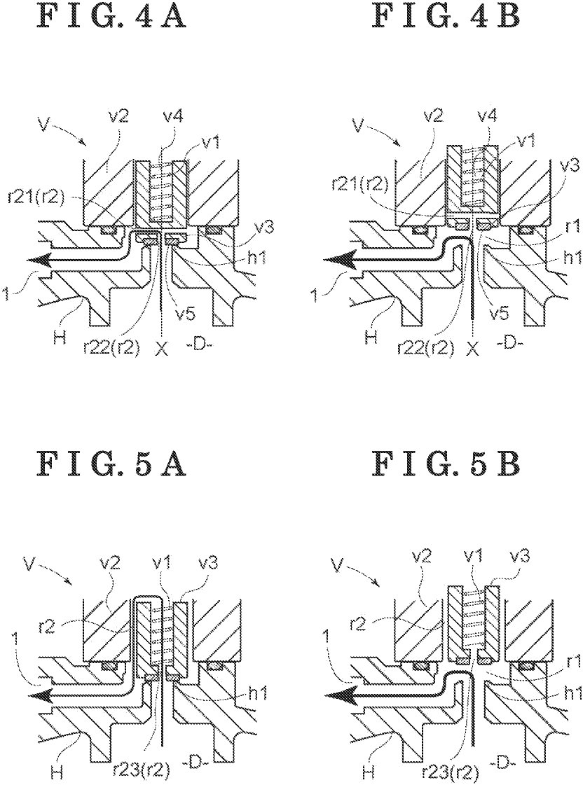

FIGS. 5A and 5B show the air pressure adjusting device S according to a second embodiment. The present embodiment is the same as the first embodiment in that the switch valve V includes the coil v2 and the valve body v3 having a plunger function. An opening of the second flow path r2 with respect to the connection port 1 is formed by a gap between the valve body v3 and the coil v2. On the other hand, an opening of the second flow path r2 with respect to the dryer D is formed by a vertical hole r23 penetrating the valve body v3 along a reciprocation direction. The vertical hole r23 is provided with the spring v1 as a biasing member that biases the valve body v3 toward the valve seat h1 while taking a reaction force to the switch valve V.

With this configuration, as long as the second flow path r2 is formed by the gap between the valve body v3 and the coil v2, for example, an outer diameter dimension of the valve body v3 may be smaller than an opening dimension of the coil v2 by a predetermined value, and thus the second flow path r2 can be very easily formed. When the valve body v3 is inclined at the time of reciprocating movement by providing a gap and is caught at an inner wall of the coil v2, for example, a groove portion having a predetermined cross-sectional area may be formed on a surface of the valve body v3 along the reciprocation direction.

On the other hand, it is sufficient to form the vertical hole r23 formed in the valve body v3 as a through hole along the reciprocation direction of the valve body v3, and a processing thereof is extremely easy, and a structure of the valve body v3 is also simplified. Therefore, the switch valve V can be attached to a general compressor mechanism or the like at low cost.

With such a second flow path r2, similarly to the first embodiment, high-pressure air on a connection port 1 side does not apply an external force in the reciprocation direction of the valve body v3, and the valve body v3 does not unexpectedly move. Therefore, a stable orifice function can be exhibited.

### Third Embodiment

A third embodiment shows an example of the air pressure adjusting device S in which a circulation path R is provided between the compressor C and the connection port 1, and when air is discharged from the air suspension A, moisture absorbed by the dryer D is likely to be removed.

Regarding the removal of the moisture absorbed by the dryer D, for example, in the related art described above (JP 2002-087040A), a device includes a compressor (1), a dryer (3), a low-pressure tank (5), and an air spring (7) to be controlled, and an exhaust valve (17) that releases air in a circuit to the atmosphere from between a discharge side of the compressor (1) and the dryer (3) is provided.

When the air is released to the atmosphere in this device, air in the air spring (7) or the low-pressure tank (5) flows into the dryer (3) through an orifice (9), and is released from the exhaust valve (17) while removing some of moisture absorbed by the dryer (3). The regeneration of the dryer (3) at this time is performed only when air having a constant flow rate passes through the orifice (9), and thus there is a limit in improving a regenerating efficiency of the dryer (3).

Another related art (JP 2017-171285A) includes a compressor (24), a dryer (40), a reservoir tank (38), air springs (22), and a separation check valve (33). By switching a main air line (63) and an auxiliary air line (67) by the separation check valve (33), a flow rate between the reservoir tank (38) and the air lines (63, 67) is changed, and a high exhaust speed and a normal exhaust speed can be selected. Accordingly, a reducing speed of a vehicle height can be increased.

In this device, there is also a limit to a regenerating capacity of the dryer (40). The dryer (40) is provided inside the compressor (24) together with a motor pump (48), and usually, moisture is absorbed when air from the motor pump (48) is sent to each of the air springs (22) via the dryer (40). On the other hand, the moisture can be released only when the air flows back from the dryer (40) to the motor pump (48). When the air supplied from the motor pump (48) to the air spring (22) is discharged, most of the air is released to the atmosphere through a high flow rate exhaust valve (31) or a suspension valve (30) provided in the vicinity of the separation check valve (33), and thus an amount of air flowing back through the dryer (40) is small. Therefore, in the related art, it cannot be said that the regenerating capacity of the dryer (40) is sufficient.

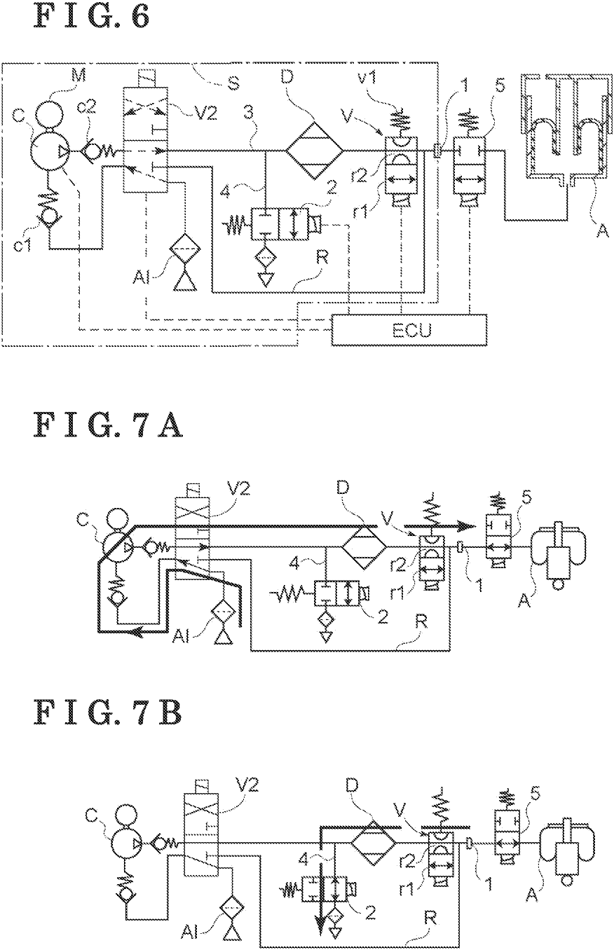

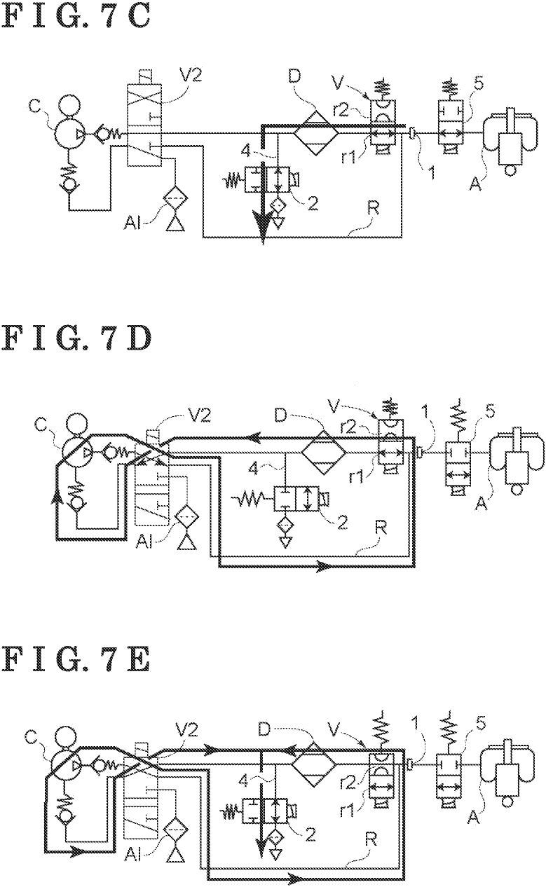

Therefore, the device S according to the present embodiment has a configuration shown in FIG. 6 and FIGS. 7A to 7E, for example, in order to enhance the regenerating capacity of the dryer D. FIG. 6 is a block diagram showing the configuration of the air pressure adjusting device S according to the present embodiment. FIGS. 7A to 7E show an operation mode or the like of constituent members at the time of moisture removal.

Specifically, as shown in FIG. 6, a second switch valve V2 is provided downstream of the compressor C and upstream of the dryer D and the exhaust valve 2. Although not illustrated, the second switch valve V2 can be provided, for example, in a part of a housing of the compressor C. The second switch valve V2 includes a solenoid and can be switched between two positions. The second switch valve V2 includes two upstream ports and three downstream ports. The two upstream ports are connected to an upstream portion and a downstream portion of the compressor C. In addition, the three downstream ports are connected to a flow path directed toward the dryer D and the exhaust valve 2, the circulation path R, and an outside air suction portion Al when the compressor C sucks the outside air.

The circulation path R is connected to one of the downstream ports of the second switch valve V2 and a position between the switch valve V and the air suspension A.

The second switch valve V2 is switchable between, for example, a first state in which air is compressed and supplied to the air suspension A and a second state in which the air is removed from the air suspension A and then moisture absorbed by the dryer D is removed.

In the first state, a discharge port of the compressor C is connected to the dryer D and the exhaust valve 2, and a suction port of the compressor C is connected to the outside air suction portion Al (see FIGS. 7A to 7C). At this time, the circulation path R is blocked. The first state is the same as a flow path configuration in the first embodiment. On the other hand, in the second state, the discharge port of the compressor C is connected to the circulation path R, and the suction port of the compressor C is connected to the dryer D and the exhaust valve 2 (see FIGS. 7D and 7E).

An operation mode of the air pressure adjusting device S in the first state and the second state will be described below. FIG. 7A shows a state in which the vehicle height is increased in the first state. The air compressed by the compressor C is sent to the air suspension A after the moisture is removed by the dryer D. At this time, the circulation path R is blocked, and the suction port of the compressor C communicates with the outside air suction portion Al.

FIG. 7B shows a state in which the vehicle height is reduced at a normal speed. The circulation path R is blocked, and the switch valve V is switched to the second flow path r2 which is an orifice having a small air flow rate. The air from the air suspension A passes through the switch valve V, and the moisture absorbed by the dryer D is taken into the air and then released from the exhaust valve 2. This state is, for example, a situation in which it is not necessary to rapidly reduce the vehicle height, and is, for example, a case in which the dryer D is regenerated at a normal exhaust speed in auto-leveling, vehicle speed sensing, and the like. In this state, since the air having a reduced flow rate and a decreased pressure passes through the inside of the dryer D, an effect of removing the moisture absorbed by the dryer D is enhanced.

FIG. 7C shows a state in which the vehicle height is rapidly reduced. At this time as well, the circulation path R is in a blocked state. The switch valve V is switched to the first flow path r1 having a large air flow rate, and the air in the air suspension A is released at once via the switch valve, the dryer D, and the exhaust valve 2. At this time, although a large flow rate of air flows back through the dryer D, a pressure of the air is high, and an amount of moisture taken into the air from the moisture absorbed by the dryer D is small. Therefore, a regenerating effect of the dryer D is small.

FIG. 7D shows a first step of regenerating the dryer D. Here, the second switch valve V2 is set to the second state. The discharge port of the compressor C is connected to the circulation path R, and the suction port of the compressor C is connected to the dryer D. The switch valve V is switched to the first flow path r1 having a large air flow rate. This state is set after the vehicle height is rapidly reduced, for example, when a passenger gets on or off a vehicle or when a load is loaded. After the vehicle height is reduced, the air suspension A also stores a predetermined amount of compressed air. Therefore, the inside of the dryer D and the inside of the circulation path R are balanced with the air suspension A and have a pressure higher than the atmospheric pressure. A switch operation of the second switch valve V2 can be performed according to, for example, a switch operation made by a user.

In this state, the compressor C is operated for a predetermined time, and circulates air through the dryer D and the circulation path R. The air flowing through the dryer D is reversed from an air suspension A side toward the compressor C. The circulating air is heated by heat generated in the compressor C or the like, and heats the inside of the dryer D. Accordingly, the moisture absorbed by the dryer D is likely to be released.

Inverting an air flow direction with respect to the dryer D during the heating is convenient because a moisture absorption distribution inside the dryer D is maintained. The moisture absorbed by the dryer D is one when high-pressure air from the compressor C passes toward the air suspension A. Therefore, the distribution of the absorbed moisture is large in an upstream region close to the compressor C and small in a downstream region close to the air suspension A.

When air flows through the dryer D in the same direction as a normal supply operation, the moisture upstream of the dryer D is dispersed downstream of the dryer D, and the moisture remaining inside the dryer D is less likely to be efficiently removed when the air flows back through the dryer D toward the exhaust valve 2. In order to prevent this inconvenience, in the present embodiment, the air flow direction when the second switch valve V2 is in the second state is reversed.

FIG. 7E shows a second step of regenerating the dryer D. Here, the second switch valve V2 is maintained in the second state and the compressor C is stopped. Subsequently, the exhaust valve 2 is open, and the switch valve V is switched to the second flow path r2 having a small air flow rate.

Accordingly, the air, which has a pressure higher than the atmospheric pressure, is heated, and takes in a certain amount of moisture, passes through inside of the dryer D in a state in which the flow rate is reduced and the pressure is decreased. Specifically, the air between the suction port of the compressor C and the discharge path 4 is directly discharged from the exhaust valve 2, and a part of the air in the downstream circulation path R from the discharge port of the compressor C and the air between the connection port 1 and the switch valve V are discharged via the dryer D. In this way, the moisture absorbed by the dryer D is effectively taken in and discharged from the exhaust valve 2.

As described above, by providing the second switch valve V2 and the circulation path R, it is possible to rapidly reduce the vehicle height, prevent an increase in weight, and obtain the low-cost air pressure adjusting device S with a small mounting space. Further, the moisture retained in the dryer D can be efficiently discharged. In particular, after the air in the air suspension A is rapidly discharged, by performing the first step and the second step by setting the second switch valve V2 to the second state and defining the air flow direction with respect to the dryer D, an effect of removing moisture absorbed by a dehumidifying agent of the dryer D can be enhanced, and the dryer D can always be maintained in a good state.

### Other Embodiments

According to the above-described embodiments, the switch valve V is provided integrally with an upper portion of the dryer D. However, in a case in which a product height of the air pressure adjusting device S has a problem in mounting, the switch valve V does not necessarily need to be provided integrally with the dryer D, and may be connected by a separate connection pipe or the like.

The air pressure adjusting device according to this disclosure can be widely used as one to be connected to a device that needs to rapidly discharge high-pressure air in another device that supplies high-pressure air.

### Characteristic Configuration

An air pressure adjusting device according to this disclosure includes: a compressor configured to compress air taken in from outside; a dryer connected to the compressor and filled with a reversible dehumidifying agent; a connection port through which air dehumidified by the dryer is supplied to another device; an exhaust valve provided between the compressor and the dryer and configured to discharge air from the dryer; and a switch valve provided between the dryer and the connection port and configured to switch between a first flow path having a large air flow rate and a second flow path having a small air flow rate.

### Effects

The switch valve of this configuration is provided between the dryer and the connection port. Usually, the air supplied to the other device is dehumidified by the dryer, and when the air is discharged from the other device, the air flows through the dryer to remove moisture absorbed by the dryer, thereby regenerating the dryer. Therefore, an orifice with a predetermined amount of air flow rate is provided between the dryer and the connection port.

However, in this configuration, the switch valve can be provided between the dryer and the connection port to switch to the first flow path having a large air flow rate. Accordingly, for example, when the air is discharged from the other device, a large flow rate of air flows through the dryer, and a regeneration function of the dryer cannot be sufficiently exhibited. However, with this configuration, the air can be quickly discharged from the other device.

Therefore, for example, when the other device to which the air pressure adjusting device is connected is an air suspension, air in the air suspension can be quickly discharged, and a vehicle height can be quickly adjusted down.

The air pressure adjusting device according to this disclosure is generally provided with a switch valve at a location where an air flow rate is reduced in order to cause the dryer to function, and a rapid air discharge effect is obtained by temporarily avoiding the limitation of an air flow rate of the dryer.

### Characteristic Configuration

In the air pressure adjusting device according to this disclosure, the switch valve includes an annular valve seat whose outer circumference communicates with the connection port and whose inner circumference communicates with the dryer, and a valve body that comes into contact with or separates from the valve seat, the first flow path is formed in a gap between the valve body and the valve seat in a state in which the valve body is separated from the valve seat, and the second flow path penetrates the valve body so as to communicate the connection port with the dryer in a state in which the valve body is in contact with the valve seat.

### Effects

With this configuration, an opening area of the first flow path is determined by a gap formed along an entire circumference of the valve seat, and an opening area of the second flow path is determined by, for example, a size of a hole portion penetrating the valve body. In particular, the first flow path formed along the entire circumference of the valve seat can have a large opening area according to a movement distance of the valve body. With this configuration, the first flow path and the second flow path having different air flow rates can be likely to be formed with a simple configuration.

### Characteristic Configuration

In the air pressure adjusting device according to this disclosure, the switch valve includes a solenoid, and the valve body is a plunger that reciprocates with respect to a coil of the solenoid, an opening of the second flow path with respect to the connection port is formed on an outer surface having a normal line intersecting with a reciprocation direction of the valve body, an opening of the second flow path with respect to the dryer is formed on an outer surface having a normal line along the reciprocation direction of the valve body, and a biasing member configured to bias the valve body toward the valve seat is provided.

### Effects

With this configuration, when the switch valve is not energized, the valve body comes into contact with the valve seat, and the second flow path having a small air flow rate is open in a normal state. In a state in which the second flow path functions, even when a pressure of the other device connected to the connection port is high, the opening of the second flow path with respect to the connection port is oriented in a direction intersecting the reciprocation direction of the valve body, and thus the valve body does not unexpectedly move due to the pressure of the other device. Therefore, the flow of air can be reliably controlled.

On the other hand, when high-pressure air is supplied to the other device, the opening of the second flow path with respect to the dryer is oriented in a direction along the reciprocation direction of the valve body. When an internal pressure of the dryer is high, a high pressure acts on the valve body in a direction in which the valve body is pushed into. Therefore, when the switch valve is energized, the valve body, which is the plunger, moves quickly, and the high-pressure air can be quickly supplied to the other device.

### Characteristic Configuration

In the air pressure adjusting device according to this disclosure, the switch valve includes a solenoid, and the valve body is a plunger that reciprocates with respect to a coil of the solenoid, an opening of the second flow path with respect to the connection port is formed by a gap between the valve body and the coil, an opening of the second flow path with respect to the dryer is formed by a vertical hole penetrating the valve body along a reciprocation direction, and a biasing member that biases the valve body toward the valve seat is provided in the vertical hole.

### Effects

With this configuration, when the switch valve is not energized and the valve body comes into contact with the valve seat, the second flow path is formed by a gap between the valve body and the switch valve. Therefore, the valve body does not unexpectedly move due to a high pressure or the like on a connection port side, and a stable orifice function can be exhibited.

It is sufficient to form a through hole on the valve body along the reciprocation direction of the valve body as the vertical hole, and a processing thereof is extremely easy, and a structure of the valve body is simplified. Therefore, the switch valve can be attached to a general compressor mechanism or the like at low cost.

### Characteristic Configuration

The air pressure adjusting device according to this disclosure further includes: a second switch valve provided between the compressor and the dryer and between the compressor and the exhaust valve; and a circulation path connecting a position between the switch valve and the connection port, and the second switch valve, and the second switch valve is switchable between a first state in which the compressed air from the compressor is supplied to the dryer and the circulation path is blocked and a second state in which the air from the compressor is supplied to the dryer via the circulation path in a reverse direction, and the air that passes through the dryer is returned to the compressor.

### Effects

With this configuration, a supply direction of air to the dryer can be changed by switching the second switch valve. Accordingly, moisture absorbed by the dryer can be efficiently discharged. For example, when air is discharged from an operation target, the switch valve is switched to the first flow path to increase a flow rate of the air flowing through the dryer.

Accordingly, air can be discharged from the exhaust valve by flowing a large flow rate of air through the dryer, but at this time, the regeneration function of the dryer for removing moisture from a dehumidifying agent is not sufficiently exhibited, and a moisture absorption amount of the dehumidifying agent increases toward a front side along an air flow direction inside the dryer. The air passing through the dryer is discharged from the exhaust valve downstream of the dryer, but the dehumidifying agent is not sufficiently regenerated and the moisture remains.

With this configuration, in order to further discharge the remaining moisture, the second switch valve is switched to reverse the air flow direction with respect to the dryer, and the air from the compressor can be supplied. Since the supplied air is heated by an operation heat of the compressor, the moisture absorbed by the dehumidifying agent is likely to be removed. In addition, when the air flow direction is reversed, high-temperature air flows from a side where the moisture absorption amount is small to a side where the moisture absorption amount is large in the dehumidifying agent, and thus the absorbed moisture does not diffuse and become uniform inside the dryer. Since a portion having the largest amount of moisture is located most downstream in this case, the moisture in the dryer can be efficiently discharged.

### Characteristic Configuration

It is convenient that a method for operating the air pressure adjusting device according to this disclosure includes: after switching the second switch valve to the second state, a first step of switching the switch valve to the first flow path to increase an air flow rate; and a second step of switching the switch valve to the second flow path to decrease an air flow rate and releasing the exhaust valve.

### Effects

According to this method, in the first step, the air heated by the operation heat of the compressor flows back through the dryer at a large flow rate, and circulates between the dryer and the compressor. Accordingly, the moisture absorbed by the dehumidifying agent of the dryer is absorbed in circulating air in a state in which a gradient change of the moisture absorption amount at each portion of the dehumidifying agent does not greatly change.

Next, in the second step, the switch valve is switched to a second flow path side having a small flow rate, and the exhaust valve is released. Accordingly, the air slowly passes through the inside of the dryer, and the moisture absorbed by the dehumidifying agent can be reliably removed.

Thus, according to this method, an effect of removing the moisture absorbed by the dehumidifying agent of the dryer is enhanced, and the dryer can always be maintained in a good state.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An air pressure adjusting device comprising:
a compressor configured to compress air taken in from outside;
a dryer connected to the compressor and filled with a reversible dehumidifying agent;
a connection port through which air dehumidified by the dryer is supplied to another device;
an exhaust valve provided between the compressor and the dryer and configured to discharge air in the dryer; and
a switch valve provided between the dryer and the connection port and configured to switch between a first flow path having a large air flow rate and a second flow path having a small air flow rate.

2. The air pressure adjusting device according to claim 1, wherein
the switch valve includes an annular valve seat whose outer circumference communicates with the connection port and whose inner circumference communicates with the dryer, and a valve body that comes into contact with or separates from the valve seat,
the first flow path is formed in a gap between the valve body and the valve seat in a state in which the valve body is separated from the valve seat, and
the second flow path penetrates the valve body so as to communicate the connection port with the dryer in a state in which the valve body is in contact with the valve seat.

3. The air pressure adjusting device according to claim 2, wherein
the switch valve includes a solenoid, and the valve body is a plunger that reciprocates with respect to a coil of the solenoid,
an opening of the second flow path with respect to the connection port is formed on an outer surface having a normal line intersecting with a reciprocation direction of the valve body,
an opening of the second flow path with respect to the dryer is formed on an outer surface having a normal line along the reciprocation direction of the valve body, and
a biasing member configured to bias the valve body toward the valve seat is provided.

4. The air pressure adjusting device according to claim 2, wherein
the switch valve includes a solenoid, and the valve body is a plunger that reciprocates with respect to a coil of the solenoid,
an opening of the second flow path with respect to the connection port is formed by a gap between the valve body and the coil,
an opening of the second flow path with respect to the dryer is formed by a vertical hole penetrating the valve body along a reciprocation direction, and
a biasing member that biases the valve body toward the valve seat is provided in the vertical hole.

5. The air pressure adjusting device according to claim 1, further comprising:
a second switch valve provided between the compressor and the dryer and between the compressor and the exhaust valve; and
a circulation path connecting a position between the switch valve and the connection port, and the second switch valve, wherein
the second switch valve is switchable between a first state in which the compressed air from the compressor is supplied to the dryer and the circulation path is blocked and a second state in which the air from the compressor is supplied to the dryer via the circulation path in a reverse direction, and the air that passes through the dryer is returned to the compressor.

6. A method for operating the air pressure adjusting device according to claim 5, the method comprising:
after switching the second switch valve to the second state,
a first step of switching the switch valve to the first flow path to increase an air flow rate; and
a second step of switching the switch valve to the second flow path to decrease an air flow rate and releasing the exhaust valve.
